(19) United States
(12) Patent Application Publication
(10) Pub. No.: US 2026/0307537 A1
(43) Pub. Date: Oct. 8, 2026

(54) VEHICLE

(71) Applicant: TOYOTA JIDOSHA KABUSHIKI KAISHA, Toyota-shi (JP)

(72) Inventor: Tomoaki SUZUKI, Nagoya-shi (JP)

(73) Assignee: TOYOTA JIDOSHA KABUSHIKI KAISHA, Toyota-shi (JP)

(21) Appl. No.: 19/456,098

(22) Filed: Jan. 22, 2026

(30) Foreign Application Priority Data
Apr. 8, 2025 (JP) 2025-063617

(51) Int. Cl. B60L 58/25

(52) U.S. Cl. CPC B60L 58/25; B60L 2240/545; B60L 2250/22

(57) ABSTRACT

The vehicle includes a power storage device and a drive device. The drive device raises the temperature of the power storage device. The drive device includes a generating circuit that generates an alternating current flowing through the power storage device. The generating circuit generates an alternating current having a first amplitude when the on-board condition indicating the riding of the user of the vehicle is not satisfied, and generates an alternating current having a second amplitude smaller than the first amplitude when the on-board condition is satisfied.

### CROSS-REFERENCE TO RELATED APPLICATION

This application claims priority to Japanese Patent Application No. 2025-063617 filed on Apr. 8, 2025. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Application Publication No. 2020-178509 (JP 2020-178509 A) discloses a vehicle. This vehicle includes a secondary battery, an inverter, and a control device. The inverter includes a plurality of switching elements. The control device drives the inverter such that a ripple current flows through the secondary battery, thereby performing heating control for causing the secondary battery to generate self-heat by internal resistance thereof. The control device acquires an action state of a user of the vehicle, and performs heating control by changing a frequency (switching frequency) for controlling charging and discharging of the secondary battery in multiple stages according to the action state of the user.

### SUMMARY

Supplying an alternating current to a power storage device enables the power storage device to be heated. The alternating current generates a magnetic field in surroundings thereof, and accordingly there is a possibility that the magnetic field will leak into a vehicle cabin. When the user rides in a vehicle that is heating the power storage device, and is wearing a mobile device such as a wristwatch or the like, an operating state of the mobile device may possibly be affected by the magnetic field.

The present disclosure provides technology for reducing effects of magnetic fields, generated during heating of power storage devices of vehicles, on mobile devices of users.

A vehicle according to the present disclosure includes
a power storage device, and
a heating device.

The heating device heats the power storage device.

The heating device includes a generating circuit for generating an alternating current flowing to the power storage device. The generating circuit
generates the alternating current of a first amplitude when an on-board condition indicating that a user of the vehicle is on board, is not satisfied, and
generates the alternating current of a second amplitude that is smaller than the first amplitude when the on-board condition is satisfied.

According to the above configuration, when the on-board condition is satisfied, amplitude of the alternating current is smaller than when otherwise. Thus, the temporal rate of change of magnetic flux (change of magnetic field) in the vehicle cabin is reduced. As a result, induced electromotive force that is generated in the mobile device of the user in the vehicle is reduced. Hence, effects of the magnetic field on the mobile device can be reduced.

According to the present disclosure, effects of magnetic fields, generated during heating of the power storage devices of vehicles, on mobile devices of users, can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram illustrating an configuration of a vehicle according to a first embodiment;

FIG. 1B is a diagram illustrating an configuration of a vehicle according to a first embodiment;

FIG. 2A is a diagram for describing a detailed configuration of a power storage device and a drive device according to an embodiment of the present;

FIG. 2B is a diagram for describing a detailed configuration of a power storage device and a drive device according to an embodiment of the present;

FIG. 2C is a diagram for describing a detailed configuration of a power storage device and a drive device according to an embodiment of the present;

FIG. 3A is a diagram for describing a functional configuration and a process of a ECU (Electronic Control Unit) according to a first embodiment of the present;

FIG. 3B is a diagram for describing a functional configuration and a process of a ECU (Electronic Control Unit) according to a first embodiment of the present;

FIG. 4A is a diagram for describing a functional configuration and a process of a ECU of vehicles according to a of the second embodiment;

FIG. 4B is a diagram for describing a functional configuration and a process of a ECU of vehicles according to a of the second embodiment;

FIG. 5 is a diagram illustrating a relation between a frequency and an amplitude of a current in a second amplitude control according to a modification of the second embodiment; and

FIG. 6 is a diagram for describing an overall configuration of a vehicle according to Modifications of Embodiments 1 and 2.

### DETAILED DESCRIPTION OF EMBODIMENTS

An embodiment of the present disclosure will be described in detail below with reference to the drawings. The same or corresponding parts in the drawings are denoted by the same reference numerals, and the description thereof will not be repeated. Each of the embodiments and the modification examples thereof may be combined with each other as appropriate.

### First Embodiment

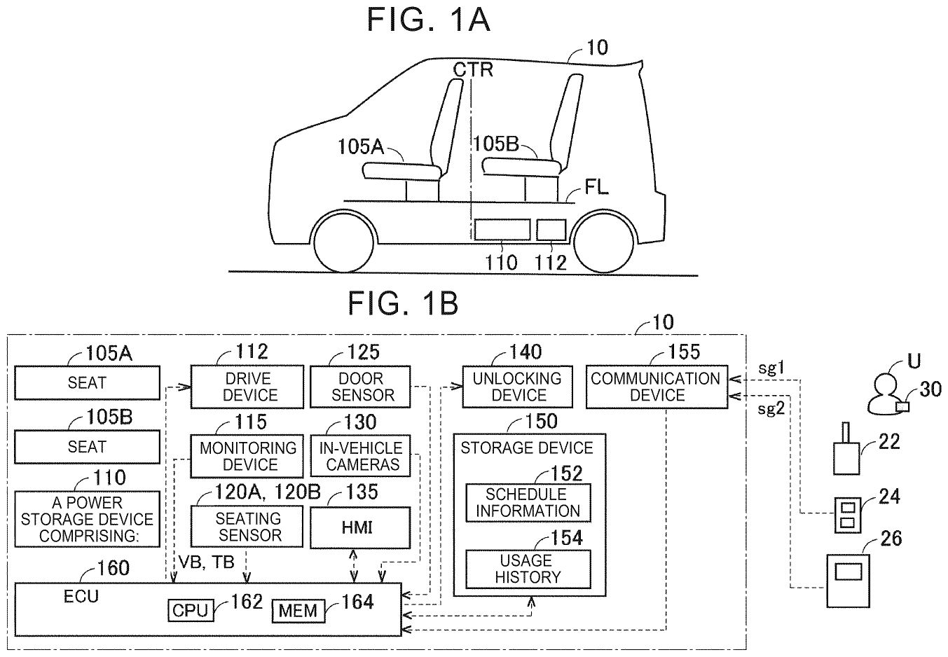

FIGS. 1A and 1B are diagrams for describing an overall configuration of vehicles according to a first embodiment. Referring to FIG. 1A of the, the vehicles 10 are battery electric vehicle (BEV: Battery Electric Vehicle) and include a seat 105A, 105B, a power storage device 110, and a drive device 112.

The seat 105A is, for example, a driver's seat or a passenger's seat, and is provided in front of a central CTR of the vehicle 10. The seat 105B is, for example, a rear seat and is provided rearward of the central CTR. The seat 105B is provided in the vicinity of the power storage device 110. The vicinity of the power storage device 110 is a region within a predetermined distance (for example, 1 meter) from the power storage device 110.

The power storage device 110 stores electric power for traveling by the vehicle 10. The drive device 112 generates the traveling driving force of the vehicle 10 by using the electric power of the power storage device 110. The power storage device 110 and the drive device 112 are provided below the floor face FL of the vehicle cabin of the vehicle 10. The power storage device 110 and the drive device 112 are provided below the seat 105B, but are not provided below the seat 105A. Detailed configurations of the power storage device 110 and the drive device 112 will be described later in detail.

Referring to FIG. 1B, the vehicle 10 further includes a monitoring device 115, a seating sensor 120A, 120B, a door sensor 125, an in-vehicle camera 130, a HMI (Human Machine Interface) device 135, a locking and unlocking device 140, a storage device 150, a communication device 155, and a ECU 160.

The monitoring device 115 is provided to monitor the state of the power storage device 110, and includes a voltage sensor, a current sensor, and a temperature sensor (none of which is illustrated). These sensors detect the voltage VB, the current, and the temperature TB of the power storage device 110, respectively.

Each of the seating sensor 120A, 120B includes a weight sensor that detects a load applied to the seat 105A, 105B. The seating sensor 120A detects that the user U of the vehicle 10 is seated in the seat 105A when the load applied thereto is equal to or greater than a predetermined threshold value. Similarly, the seating sensor 120B detects that the user U is seated in the seat 105B when the load applied thereto is equal to or greater than a threshold value. The seating sensor 120B is an exemplary “detection unit” of the present disclosure. The user U has at least one of a key 22, a keyless key (smart key) 24, or a smartphone 26, and is wearing a portable device 30 (in this example, a wristwatch).

The door sensor 125 detects that the door of the vehicle 10 has been opened. The door sensor 125 may be configured to sense contact of the vehicle 10 with a door handle. The in-vehicle camera 130 captures an image of a space in the vehicle cabin of the vehicle 10 and generates a captured image thereof. HMI device 135 includes, for example, a touch screen and is operated by various users. The user operation is, for example, an operation of inputting a schedule of the user U or an operation of designating a time (temperature rise start time) at which the temperature rise of the power storage device 110 is started.

When the key 22 is inserted into a keyhole (not shown) of the vehicle 10 and an unlocking operation is performed, the locking and unlocking device 140 switches the state of the door of the vehicle 10 from the locked state to the unlocked state. On the other hand, when the unlocking operation is performed, the locking and unlocking device 140 switches the unlocked state to the locked state.

The storage device 150 stores schedule information 152 and a usage history 154. Schedule information 152 indicates the schedule of the user U (e.g., the time when the vehicle 10 was started), and is either determined based on the user operation or synchronized with an external server that manages the user's schedule. The usage history 154 indicates a usage history of the vehicle 10, and includes, for example, a history of a start time and a stop time of the traveling system of the vehicle 10.

The communication device 155 communicates with an external server and performs close proximity wireless communication with various devices in the vicinity of the vehicle 10. When the communication device 155 receives the unlocking command sg1 from the keyless key 24 through the close proximity wireless communication or receives the unlocking command sg2 from the smartphone 26 through the close proximity wireless communication, the locking and unlocking device 140 switches the state of the door from the locked state to the unlocked state.

ECU 160 includes CPU (Central Processing Unit) 162 and memory 164. CPU 162 executes various arithmetic processes. The memory 164 includes ROM (Read Only Memory) and RAM (Random Access Memory). ROM stores various maps and programs used by CPU 162.

ECU 160 controls various devices of the vehicle 10, such as the drive device 112 and the locking/unlocking device 140, in accordance with the detection result of the monitoring device 115, the detection result of the seating sensor 120A, 120B or the door sensor 125, the captured images of the in-vehicle camera 130, or the reception result of the unlocking command by the communication device 155.

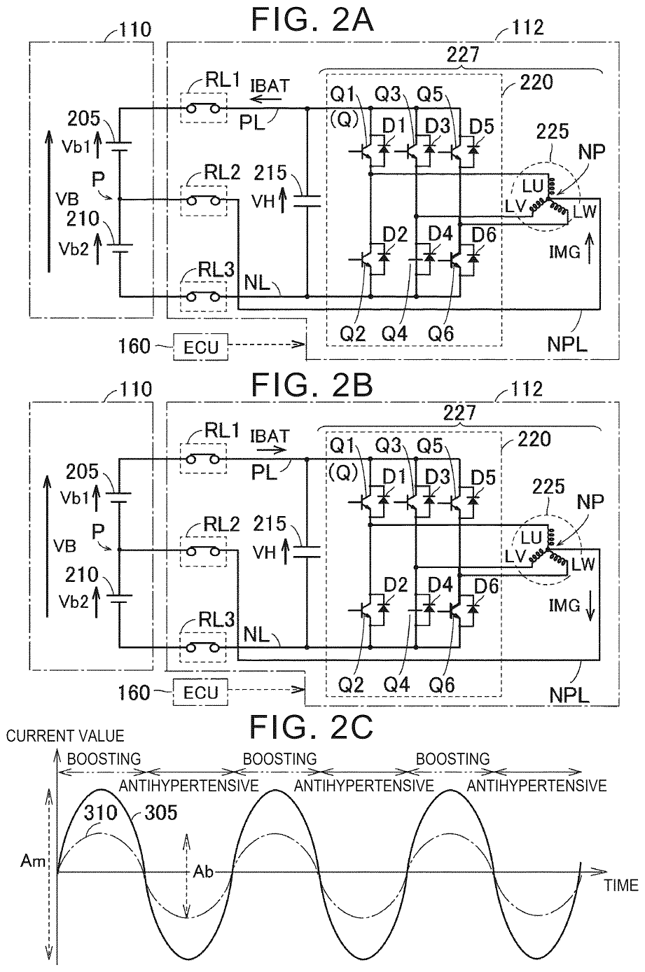

FIGS. 2A to 2C are diagrams for describing a detailed configuration of a power storage device 110 and a drive device 112. Referring to FIG. 2A, the power storage device 110 includes a battery 205, 210. The battery 205, 210 is a secondary battery such as a lithium-ion battery. The negative electrode of the battery 205 is connected to the positive electrode of the battery 210. The voltages of the batteries 205, 210 are also referred to as voltage Vb1, Vb2. The sum of the voltage Vb1, Vb2 corresponds to the voltage VB. The power line connecting the battery 205, 210 branches off from the branch point P. The current IBAT is an alternating current flowing through the power storage device 110. The positive direction of the current IBAT is the direction of the arrow shown in FIG. 2A.

The drive device 112 includes a RL3 from a relay RL1, a smoothing capacitor 215, an inverter 220, and a motor 225.

The relay RL1 is connected to the positive electrode of the battery 205. The relay RL2 is connected to the branch point P. The relay RL3 is connected to the negative electrode of the battery 210. In this instance, each of the relaying RL1 to RL3 is closed. The smoothing capacitor 215 is connected between the high potential line PL and the low potential line NL. The voltage of the smoothing capacitor 215, that is, the voltage between the high potential line PL and the low potential line NL, is also represented by a voltage VH.

Inverter 220 includes switching elements Q1 through Q6 and diode D1 through

D6. Each of the switching elements Q1 to Q6 is, for example, IGBT (Insulated Gate Bipolar Transistor) and is connected between the high potential line PL and the low potential line NL. The switching elements Q1, Q3, Q5 each operate in a complementary manner to the switching elements Q2, Q4, Q6. Each of the switching elements Q1 to Q6 is also referred to as a switching element Q.

The switching elements Q are driven by PWM (Pulse Width Modulation) control by a ECU 160. Specifically, ECU 160 generates a signal for commanding the waveform of the current IBAT (hereinafter, also simply referred to as a “command signal”), generates a PWM signal by comparing the waveform and the carrier wave, and drives the respective switching elements Q in accordance with PWM signal. The command signal is generated as a sinusoidal alternating current signal representing a temporal change in the target current IBAT. The driving frequency (switching frequency) of the respective switching elements Q is preferably set to be higher than the upper limit of the audible range, and in this case, is higher than 20kHz. The diodes D1 to D6 are provided in anti-parallel from the switching elements Q1 to Q6, respectively.

The motor 225 includes a three-phase winding. The neutral point NP of the three-phase winding is connected to one end of the power line NPL. The other end of the power line NPL is connected to a relay RL2. The U-phase winding LU of the three-phase winding is connected to the switching element Q1, Q2. The V-phase winding LV of the three-phase winding is connected to the switching element Q3, Q4. The W-phase winding LW of the three-phase winding is connected to the switching element Q5, Q6.

ECU 160 is capable of executing a self-temperature-raising control for controlling the inverters 220 so that the self-temperature-raising of the power storage device 110 is performed. The self-heating of the power storage device 110 is to raise the temperature of the power storage device 110 by self-heating caused by the internal resistance thereof by passing a current through the power storage device 110. The self-temperature increase is mainly performed before charging of the power storage device 110 at a low temperature or the like in order to effectively charge the power storage device 110. During the self-temperature-raising control, the drive device 112 functions as a heating device that raises the temperature of the power storage device 110. The self-temperature-raising control is executed, for example, when a temperature-raising condition for raising the temperature of the power storage device 110 is satisfied while the vehicle 10 is stopped. The temperature increase condition is, for example, that the temperature TB is lower than the threshold temperature. The temperature TB may be the temperature of any of the batteries 205, 210 or the mean temperature of these batteries. The temperature rise condition may be that the temperature rise start time designated by the user operation arrives.

The self-temperature-raising control corresponds to performing a voltage-raising operation or a voltage-lowering operation with respect to the voltage of the power storage device 110 to control the inverters 220 so that electric power is exchanged between the batteries 205, 210 and a current IBAT flows through the power storage device 110 (generating a command signal). The step-up operation is an operation of boosting the voltage Vb2 so that the positive current IBAT flows from the battery 210 to the battery 205. The step-down operation is an operation of stepping down the voltage VB so that a negative current IBAT flows from the battery 205 to the battery 210. During the self-heating control, the inverter 220 and the motor 225 function as an alternating current generating circuit 227 that generates a current IBAT. The alternating current flowing in the power line NPL during the self-heating control is also represented as a current IMG. The positive direction of the current IMG is the direction of the arrow shown in FIG. 2A.

Hereinafter, a specific procedure of the above-described step-up operation will be described. In this example, for simplicity of explanation, only the U-phase of the inverter 220 is assumed to operate.

First, so that a current flows from the positive electrode of the battery 210 to the negative electrode of the battery 210 through the branch point P, the power line NPL, the neutral point NP, and the switching element Q2 (the current IMG flows in the power line NPL), the switching element Q1 is turned off and the switching element Q2 is turned on. As a result, a current flows through the U-phase winding LU of the motor 225 to store energy.

Next, the switching element Q1 is turned on so that a current flows from the positive electrode of the battery 210 to the smoothing capacitor 215 through the branch point P, the power line NPL, the neutral point NP, and the switching element Q1 (the current IMG flows in the power line NPL), and the switching element Q2 is turned off. As a result, the energy stored in the U-phase winding LU flows to the smoothing capacitor 215, and the voltage VH increases. The current is maintained due to self-induction of the U-phase winding LU.

Next, each of the switching elements Q1, Q2 is turned off so that the current IBAT flows from the high potential of the smoothing capacitor 215 to the power storage device 110. This is because the voltage VH is higher than the voltage VB (=Vb1+Vb2) at this point.

The specific steps of the above-described step-down operation will be described referring to FIG. 2B. In this example, for the sake of simplicity of explanation, only the U-phase of the inverter 220 is operated.

First, the switching element Q1 is turned on so that a current flows from the high potential of the smoothing capacitor 215 to the positive electrode of the battery 210 through the switching element Q1, the neutral point NP, the power line NPL, and the branch point P (a current IMG flows in the power line NPL), and the switching element Q2 is turned off. As a result, a current flows through the U-phase winding LU and energy is stored.

Next, the switching element Q1 is turned off and the switching element Q2 is turned on so that the energy stored in the U-phase winding LU is released and a current flows from the U-phase winding LU to the neutral point NP, the power line NPL, and the battery 210 (a current IMG flows in the power line NPL). This current is maintained due to self-induction of the U-phase winding LU. This is because the smoothing capacitor 215 is disconnected from the U-phase winding.

Next, each of the switching elements Q1, Q2 is turned off so that the current IBAT flows from the power storage device 110 to the smoothing capacitor 215. This is because the voltage VH is lower than the voltage VB at this point.

Referring to FIG. 2C, lines 305,310 each represent a transition of the current IMG, IBAT. Each amplitude Am, Ab represents the amplitude of the current IMG, IBAT. The amplitude Ab is related to the amplitude Am, and the smaller the amplitude Am, the smaller. ECU 160 can adjust the amplitude Am, Ab by adjusting the amplitude of the command signal. For example, by increasing the amplitude of the command signal, the on-duty of the switching element Q2 can be increased to increase the amplitude Am, Ab. Conversely, by decreasing the amplitude of the command signal, the on-duty of the switching element Q2 can be decreased and the amplitude Am, Ab can be decreased.

The current IMG, IBAT has the same sinusoidal frequency. This frequency is, for example, lower than the lower limit of the audible range. Note that this frequency is the same as the frequency of the command signal, and differs from the switching frequency of the switching element Q1, Q2 (the frequency of the ripple components of the current IMG, IBAT accompanying the on-off of these switching elements Q). The amplitude Am, Ab of the current IMG, IBAT is determined according to the amplitude of the command signal.

ECU 160 performs the self-temperature rise control by controlling the switching element Q1, Q2 so that the step-up operation and the step-down operation are repeated. As a result, the direction of the current IMG, IBAT changes successively, an alternating current flows through the power storage device 110, and the self-temperature of the power storage device 110 is raised due to heat generation in the power storage device 110.

Since the current IMG, IBAT is an alternating current, an alternating magnetic field is generated in the surroundings. During the self-heating control, there is a possibility that the alternating current magnetic field leaks into the vehicle cabin of the vehicle 10. In this case, when the user U wears the portable device 30 and rides on the vehicle 10, an induced electromotive force is generated in the portable device 30. As a result, the operating state of the portable device 30 may be affected by the alternating magnetic field.

Therefore, ECU 160 of the vehicle 10 according to the first embodiment has a configuration for reducing the effect of the alternating current magnetic field generated during the self-temperature rise control on the portable device 30.

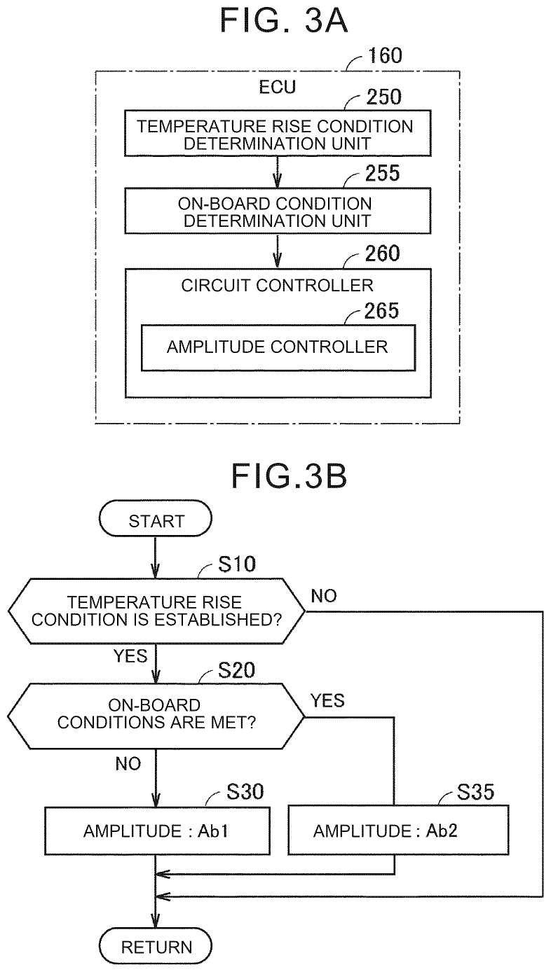

FIGS. 3A and 3B are diagrams for describing a functional configuration and a process of a ECU 160 according to a first embodiment. Referring to FIG. 3A, ECU 160 includes a temperature rise condition determination unit 250, an on-board condition determination unit 255, and a circuit control unit 260 as functional configurations thereof. These functions are performed when CPU 162 executes programs stored in the memory 164.

The temperature rise condition determination unit 250 determines whether or not the temperature rise condition is satisfied, according to the detection result of the temperature TB or whether or not the temperature rise starting time has arrived.

The on-board condition determination unit 255 determines whether or not the on-board condition indicating the boarding of the user U is satisfied. The on-board condition may be either a ride-on condition indicating that the user U is riding on the vehicle 10 or a ride-on possibility condition indicating a ride-on possibility of the user U.

The on-board condition determination unit 255 determines whether or not the boarding completion condition is satisfied, for example, in accordance with the detection result by the seating sensor 120A, 120B. In this case, the ride-on condition may be, for example, any of a first seated condition indicating that the user U is detected to be seated in the seat 105A or a second seated condition indicating that the user U is detected to be seated in the seat 105B. The on-board condition determination unit 255 may determine whether or not the riding completion condition is satisfied according to whether or not the user U is visible in the captured image of the in-vehicle camera 130.

The on-board condition determination unit 255 may determine whether or not the boarding possibility condition is satisfied according to the detection result by the door sensor 125 and whether or not the short-range communication (pairing) between the communication device 155 and the keyless key 24 or the smartphone 26 has been established. The on-board condition determination unit 255 may determine whether or not the boarding possibility condition is satisfied according to whether or not the unlocking operation has been performed by inserting the key 22, the behavior prediction result (for example, the use start time) of the user U based on the usage history 154, or the schedule information 152.

When the on-board condition is satisfied, the circuit control unit 260 controls the alternating current generating circuit 227 (specifically, controls the inverter 220) to execute the self-temperature rise control. The circuit control unit 260 includes an amplitude control unit 265.

When the on-board condition is not satisfied, the amplitude control unit 265 performs the first amplitude control for controlling the switching element Q1, Q2 of the inverter 220 so that the amplitude Ab of the current IBAT becomes Ab1. The first amplitude control is performed by generating a command signal such that the amplitude of the command signal becomes a predetermined first signal amplitude. Ab1 is stored in advance in the memory 164 as a value less than or equal to the allowable upper limit of the amplitude Ab, and corresponds to an exemplary “first amplitude” of the present disclosure. The allowable upper limit is appropriately determined in advance so that the induced electromotive force to be described later does not become excessively large. During the first amplitude control, the amplitude Am of the current IMG is assumed to be Am1.

When the on-board condition is satisfied, the amplitude control unit 265 executes the second amplitude control for controlling the switching element Q1, Q2 so that the amplitude Ab becomes Ab2. The second amplitude control is performed by generating a command signal such that the amplitude of the command signal becomes a predetermined second signal amplitude. Ab2 is smaller than Ab1 and corresponds to an exemplary “second amplitude” of the present disclosure. During the second amplitude control, the amplitude Am of the current IMG is Am2 (<Am1). In the second amplitude control, each of Ab2, Am2 may be zero. In this case, the self-heating of the power storage device 110 by the second amplitude control is not performed.

Since the current IMG, IBAT has a sinusoidal waveform, the smaller the amplitude Ab, the smaller the amplitude Am, and the smaller the temporal change rate (variation in the magnetic field) of the magnetic flux in the vehicle cabin of the vehicle 10. Therefore, the smaller the amplitude Ab, the smaller the induced electromotive force generated in the portable device 30. With the above-described functional configuration, when the on-board condition is satisfied, the amplitude Ab, Am during the self-temperature increase control becomes smaller than when the on-board condition is not satisfied. Accordingly, when the user U is riding in the vehicle cabin or the user U is scheduled to ride from this point, the rate of change of the magnetic flux in the vehicle interior with time is reduced. As a result, the induced electromotive force generated in the portable device 30 in the vehicle cabin is reduced. Therefore, it is possible to reduce the influence of the alternating current magnetic field on the operating state of the portable device 30.

The on-board condition is, for example, the above-described second seated condition. When the second seated condition is not satisfied (when the user U is not in the vehicle 10 or is seated in the seat 105A), the portable device 30 is separated from the power storage device 110. Therefore, when the second seated condition is not satisfied, the influence of the alternating current magnetic field on the portable device 30 is negligible or negligible. In such a case, since it is not necessary to consider this influence, it is preferable to effectively raise the temperature of the power storage device 110.

In the first embodiment, when the second seated condition is satisfied, the amplitude Ab during the self-temperature increase control becomes smaller than when the second seated condition is not satisfied. Thus, when the user U is seated on the seat 105B in the vicinity of the power storage device 110 and the portable device 30 is susceptible to the influence of the alternating current magnetic field, the influence of the alternating current magnetic field on the portable device 30 during the self-temperature rise control can be reduced. On the other hand, when the second seated condition is not satisfied, the amplitude Ab is larger than when the second seated condition is satisfied. Therefore, when the user U is not seated in the seat 105B and the effect of the alternating current magnetic field on the portable device 30 is not or is negligibly small, the amount of heat generated in the power storage device 110 can be increased to effectively raise the temperature of the power storage device 110.

FIG. 3B is a flowchart illustrating a of a ECU 160 according to a first embodiment. This flowchart is executed at predetermined time intervals. Hereinafter, the step is abbreviated as “S”.

Referring to FIG. 3B, ECU 160 determines whether the temperature increase condition is satisfied (S10). If the temperature rise condition is not satisfied (NO in S10), the process proceeds to return. When the temperature rise condition is satisfied (YES in S10), the process proceeds to S20.

ECU 160 determines whether the on-board condition is satisfied (S20). When the on-board condition is not satisfied (NO in S20), ECU 160 performs the first amplitude control in which the amplitude Ab is Ab1 (S30). On the other hand, when the on-board condition is satisfied (YES in S20), ECU 160 executes second amplitude control in which the amplitude Ab is Ab2 (S35). After S30 or S35, the process proceeds to returns.

As described above, when the on-board condition (the on-board condition or the on-board condition) is satisfied, the amplitude Ab, Am is smaller than that in the case where the on-board condition is not satisfied. Accordingly, when the user U is riding in the vehicle cabin or the user U is scheduled to ride from this point, the rate of change of the magnetic flux in the vehicle interior with time is reduced. As a result, the induced electromotive force generated in the portable device 30 in the vehicle cabin is reduced. Therefore, it is possible to reduce the influence of the alternating current magnetic field on the operating state of the portable device 30.

### Embodiment 2

ECU 160 of the vehicle 10 according to the second embodiment sets the frequency (sinusoidal frequency) of the command signal during the self-temperature-raising control according to whether or not the on-board condition is satisfied.

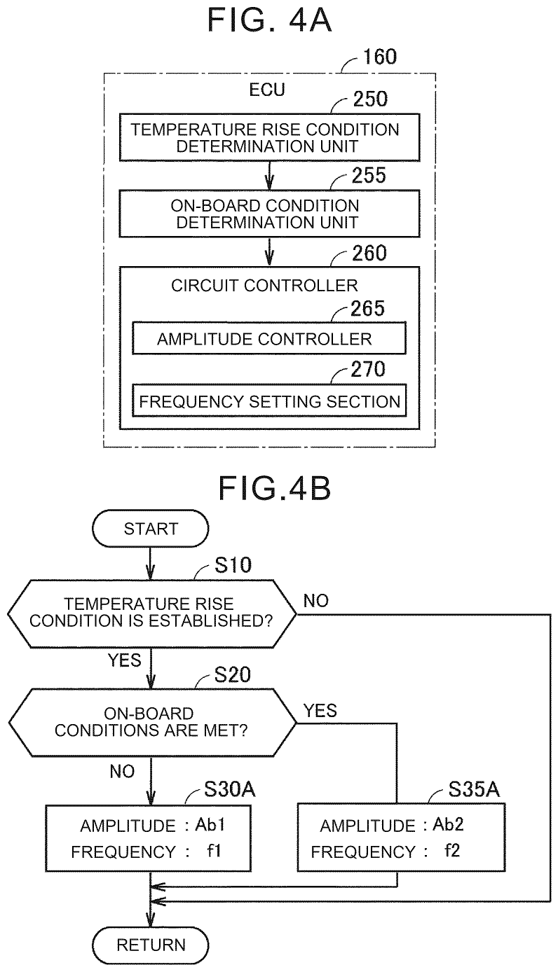

FIGS. 4A and 4B are diagrams for describing a functional configuration and a process of a ECU 160 of vehicles 10 according to a second embodiment. Referring to FIG. 4A, the vehicle 10 according to the second embodiment differs from the vehicle 10 according to the first embodiment in that ECU 160 circuit control unit 260 further includes a frequency-setting unit 270. The vehicle 10 according to the second embodiment is the same as the vehicle 10 according to the first embodiment with respect to other configurations and processing procedures, unless otherwise specified. Therefore, the detailed description will not be repeated. The same applies to the modification described later.

During the first amplitude control, the frequency setting unit 270 sets the frequency of the command signal to f1. f1 corresponds to an exemplary “first frequency” of the present disclosure. On the other hand, during the second amplitude control, the frequency setting unit 270 sets the frequency of the command signal to f2. f2 is lower than f1 and corresponds to an exemplary “second frequency” of the present disclosure.

The lower the frequency of the command signal, the lower the frequency of the current IMG, IBAT. The lower the frequency of the current IMG, IBAT, the smaller the induced electromotive force generated in the portable device 30 in the vehicle during the self-temperature rise control. Therefore, the lower the frequency of the command signal, the smaller the induced electromotive force. With the above-described functional configuration, when the on-board condition is satisfied, the current IMG, IBAT has a smaller amplitude Am, Ab and a lower frequency of the current IMG, IBAT than when the on-board condition is not satisfied. As a result, the induced electromotive force generated in the portable device 30 in the vehicle 10 becomes smaller. As a result, the influence of the alternating current magnetic field on the portable device 30 can be more effectively reduced.

FIG. 4B is a flowchart illustrating a of a ECU 160 according to a second embodiment of the present disclosure. This flowchart is the same as the flowchart of the first embodiment except that S30A, S35A is executed instead of S30, S35.

When the on-board condition is not satisfied (NO in S20), ECU 160 executes the first amplitude control in which the amplitude Ab is Ab1 and sets the frequency of the command signal to f1 (S30A). On the other hand, when the on-board condition is satisfied (YES in S20), ECU 160 executes the second amplitude control in which the amplitude Ab is Ab2, and sets the frequency of the command signal to f2 (S35A).

As described above, according to the second embodiment, when the on-board condition is satisfied, the current IMG, IBAT has a smaller amplitude Am, Ab and a lower frequency of the current IMG, IBAT than when the on-board condition is not satisfied. As a result, the induced electromotive force generated in the portable device 30 in the vehicle 10 becomes smaller. As a result, the influence of the alternating current magnetic field on the portable device 30 of the user U can be more effectively reduced.

When the on-board condition is satisfied (YES in S20), ECU 160 may execute the first amplitude control and set the frequency of the command signal to f2. That is, the amplitude may be kept constant both when the on-board condition is satisfied or when the on-board condition is not satisfied, and the command signal may be generated so that the frequency becomes low when the on-board condition is satisfied. As a result, since the induced electromotive force becomes smaller, the influence of the alternating current magnetic field on the portable device 30 can be reduced.

### Modification of the Second Embodiment

In this modification, when the temperature TB is lower, the frequency setting unit 270 sets f2 lower than when the temperature TB is higher, and the amplitude control unit 265 performs the second amplitude control so as to increase Am2. In this case, the second amplitude-control is performed such that the lower the temperature TB, the lower f2 and the larger Am2. If the temperature TB falls below the threshold temperature, a second amplitude-control may be performed such that f2 is lowered and Am2 is increased.

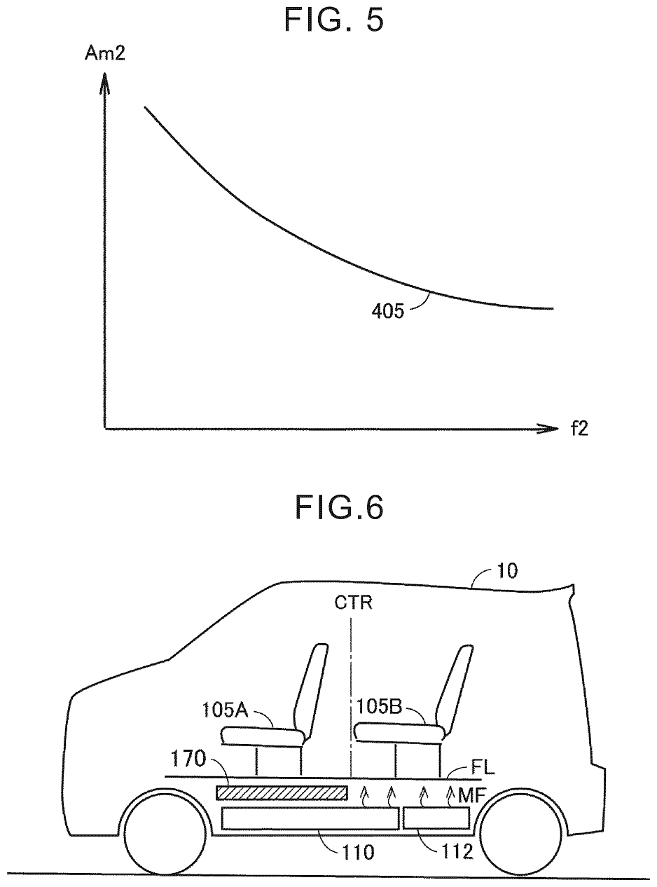

FIG. 5 is a diagram illustrating a relation between the frequency (f2) and the amplitude (Am2) of the current IMG, IBAT in the second amplitude control of this modification. In this instance, the lower f2 (the lower the temperature TB), the greater Am2, as indicated by line 405.

The lower the frequency of the command signal, the lower the frequency of the current IMG, IBAT. The lower the frequency, the smaller the induced electromotive force generated in the portable device 30 in the vehicle 10. Therefore, when f2 is low, the induced electromotive force does not become excessively large even if Am2 is large to some extent. Therefore, the lower f2, the higher the allowable upper limit of Am2.

In this variation, when the temperature TB is lower, f2 is lower (the upper limit of Am2 is higher) and Am2 is larger than when the temperature TB is higher. Thus, even when the on-board condition is satisfied, the amount of heat generated in the power storage device 110 during the self-temperature increase control can be increased while preventing the induced electromotive force from becoming excessively large. As a result, it is possible to effectively raise the temperature of the power storage device 110 while avoiding an excessive influence of the alternating current magnetic field on the portable device 30.

### Modification of the First and Second Embodiments

FIG. 6 is a diagram for explaining an overall configuration of the vehicle 10 according to this modification. Referring to FIG. 6, the vehicle 10 of this modification further includes a magnetic field shielding member 170, and differs from the vehicle 10 of the first embodiment in that the power storage device 110 is wider below the floor face FL.

The magnetic field shielding member 170 is, for example, an iron plate, and shields the alternating current magnetic field MF derived from the current IMG, IBAT. The magnetic field shielding member 170 is provided between the power storage device 110 and the floor face FL. The magnetic field shielding member 170 is provided below the seat 105A, but is not provided below the seat 105B. In this case, during the self-temperature rise control, there is a possibility that the alternating current magnetic field MF leaks in the vicinity of the seat 105A while the alternating current magnetic field MF does not leak in the vicinity of the seat 105A in the vehicle cabin. Consequently, when the user U is seated in the seat 105A, the operating state of the portable device 30 is not affected by the alternating current magnetic field MF, while when the user U is seated in the seat 105B, the operating state of the portable device 30 may be affected by the alternating current magnetic field MF.

Also in the first modification, the ride-on condition includes the above-described second seated condition indicating that the user U is seated in the seat 105B and detected by the seating sensor 120B.

When the user U is not seated in the seat 105B (for example, when the user U is not in the vehicle 10 or is seated in the seat 105A), the effect of the alternating current magnetic field MF on the portable device 30 is negligibly small. In such a case, since it is not necessary to consider this influence, it is preferable to effectively raise the temperature of the power storage device 110.

In this modification as well, when the second seated condition is satisfied, the amplitude Ab, Am is smaller than when the second seated condition is not satisfied. Thus, when the user U is seated on the seat 105B and the portable device 30 is easily affected by the alternating current magnetic field MF, the effect of the alternating current magnetic field MF on the portable device 30 during the self-temperature rise control can be reduced. On the other hand, when the second seated condition is not satisfied, the amplitude Ab, Am is larger than when the second seated condition is satisfied. Therefore, when the user U is not seated in the seat 105B and the effect of the alternating current magnetic field MF on the portable device 30 is not or is negligibly small, the amount of heat generated in the power storage device 110 can be increased to effectively raise the temperature of the power storage device 110.

### Other Variations

ECU 160 may be configured to be capable of generating a signal indicative of a temporal change in the target value of the voltage VH. In the step-up operation, since the on-duty of the switching element Q2 is higher as the target voltage VH is higher, the amplitude Am, Ab is large and the positive current IBAT is large. On the other hand, in the step-down operation, since the on-duty of the switching element Q1 is higher as the target voltage VH is lower, the amplitude Am, Ab is large and the negative current IBAT is large. As described above, ECU 160 may adjust the amplitude Am, Ab based on the signal indicating the temporal change of the target value of the voltage VH instead of the command signal.

Vehicle 10 may be a hybrid electric vehicle (HEV) that further comprises a fuel-powered engine, such as gasoline or hydrogen.

The self-temperature rise control is executed by driving only the switching element Q1, Q2, but may be executed by driving all of Q6 from the switching element Q1.

It should be considered that the embodiment described herein is just an example in all respects and is not limitative. It is intended that the scope of the disclosure be defined by the appended claims rather than the foregoing description, and that all changes within the meaning and range of equivalency of the claims be embraced therein.

What is claimed is:

1. A vehicle, comprising:
a power storage device; and
a heating device for heating the power storage device, wherein
the heating device includes a generating circuit for generating an alternating current flowing to the power storage device, and
the generating circuit
generates the alternating current of a first amplitude when an on-board condition indicating that a user of the vehicle is on board, is not satisfied, and
generates the alternating current of a second amplitude that is smaller than the first amplitude when the on-board condition is satisfied.

2. The vehicle according to claim 1, wherein the on-board condition includes a condition indicating an on-board possibility of the user.

3. The vehicle according to claim 1, wherein
frequency of the alternating current of the first amplitude is a first frequency, and
frequency of the alternating current of the second amplitude is a second frequency that is lower than the first frequency.

4. The vehicle according to claim 3, further comprising a temperature sensor for detecting a temperature of the power storage device, wherein, when the temperature is low, the second frequency is lower and the second amplitude is larger than when the temperature is high.

5. The vehicle according to claim 1, wherein
the power storage device is provided below a floor face of a vehicle cabin of the vehicle,
the vehicle further comprising:
a magnetic field shielding member provided between the power storage device and the floor face;
a seat beneath which the magnetic field shielding member is not provided; and
a detection unit that detects that the user is seated in the seat, and
the on-board condition includes a seated condition indicating the detection unit has detected that the user is seated in the seat.
